(19) United States
(12) Patent Application Publication
(10) Pub. No.: US 2003/0124965 A1
(43) Pub. Date: Jul. 3, 2003

(54) Poultry shackle and quick-attach mounting thereof

(76) Inventors: Frank J. Criscone II, Gladstone, MO (US); Rudolf J. Tieleman, Kansas City, KS (US)

Correspondence Address: HOVEY, WILLIAMS, TIMMONS & COLLINS, Suite 400, 2405 Grand, Kansas City, MO, 64108, US

(21) Appl. No.: 10/038,015

(22) Filed: Jan. 3, 2002

(51) Int. Cl. A22C 21/00

(52) U.S. Cl. 452/188

(57) ABSTRACT

A shackle assembly has a clip that is essentially permanently affixed to the overhead conveyor in a poultry processing plant and a shackle that can be attached to and detached from the clip without the use of hand tools. Significant motion of the shackle relative to the clip is permitted without promoting accidental detachment from the clip such that the shackles can be manipulated as need be by various guide structures and the like throughout their movement along the processing line and inspectors can move the suspended carcasses into the most advantageous positions for visual inspection. However, when detachment is desired, a locking head on the shackle that is loosely confined within a key slot in the clip can be oriented in such a way as to permit the shackle to be withdrawn from or replaced within the clip when the conveying line has been disengaged and stopped. Alternative embodiments are disclosed of both the clip and the shackle, including both metal and non-metal forms.

### TECHNICAL FIELD

The present invention relates to poultry processing equipment and, more particularly, to a shackle assembly in which the shackle is quickly and easily attachable to and removable from an overhead conveyor typically used in poultry processing plants. In a preferred form, the present invention also relates to improvements in a shackle that is constructed from synthetic resinous material.

### BACKGROUND

Many poultry shackles in current use are constructed from metal. The many guide rods and other structures engaged by the shackles as they travel along a conveying line in a processing plant are also largely metallic. Consequently, the shackles tend to clank and clatter throughout their travel, creating considerable noise. Moreover, conventional metal shackles can become bent and deformed during heavy use, which impairs their ability to properly hold and position carcasses as they are moving through the plant. Sometimes, the shackles may become jammed in the processing equipment and cause serious damage.

Current all-metal systems do not provide for quick detachment and replacement of damaged metal shackles. Instead, hand tools must be utilized while considerable time is lost attending to the repair. While some plastic shackles are currently available in the marketplace, they are not fully satisfactory in all respects.

One prior art assembly utilizes a metal clip that is essentially permanently secured to the conveyor such as by bolting. The shackle of the assembly has a specially configured projection at its upper end that fits into and is retained within a receiving slot in the clip, without the use of fasteners. The slot has a narrow supporting portion in the clip floor that keeps the enlarged, generally rectangular head of the projection from falling out of the clip when the shackle is hanging vertically during normal operating conditions, as well as an enlarged access portion in the clip sidewall remote from the narrow portion and through which the enlarged head can be intentionally inserted and removed. Unless the shackle is raised into a generally horizontal orientation and rotated into such a position that the enlarged rectangular head is generally in line with the slot, the head cannot be passed through the access portion, thus making accidental disconnection of the shackle from the clip highly unlikely. A cylindrical neck immediately below the retaining head permits the shackle to be freely rotated about its longitudinal axis.

### SUMMARY OF THE INVENTION

The present invention addresses the problems of the prior art by providing an improved shackle assembly. In one preferred embodiment, the prior art metal clip is still used, but the shackle is different. One preferred form of the shackle interposes a transverse anti-rotation bar immediately below the retaining head that is normally disposed at slot level so as to engage internal side edges of the slot when rotation is attempted. To rotate the shackle, such as for installation and removal or carcass inspection, the shackle is raised until the neck is at slot level and the anti-rotation bar is positioned above the slot, whereupon rotation is no longer impeded. If desired, the anti-rotation bar may be provided with tapered opposite ends so as to permit a limited amount of rotation of the shackle in either direction about its longitudinal axis without raising the shackle, thus accommodating the slight, normal twisting and turning movements from side-to-side that are necessary during processing operations. In-and-out swinging movement of the shackle is also permitted.

In another preferred form of shackle, the rectangular locking head of the prior art shackle has been replaced with a generally oval-shaped head to improve the ease with which the shackle may be intentionally rotated within the clip during processing operations. The oval-headed shackle may or may not be provided with an anti-rotation locking bar.

The clip may comprise the prior art metal clip, or it may be constructed from a suitable synthetic resinous material. If metal is used, the clip may be fabricated from sheet metal by cutting, punching, and forming a piece into the desired shape. When completed, the sheet metal piece assumes a generally L-shaped configuration with a normally upright sidewall and a cantilevered, normally horizontally extending floor that projects out laterally from the sidewall. A hole for use in attaching the clip to the conveyor with a bolt is located at the normally upper end of the sidewall. The narrow portion of the slot runs across the floor and partially up the sidewall, where it intersects with the enlarged, access portion. The distal end of the floor is upturned to form a short, second sidewall for strength.

If the clip is constructed from a synthetic resinous material such as Nylon, it is preferred that the clip be formed symmetrically and generally U-shaped, with a pair of mirror image sidewalls that are interconnected by a common, transverse floor. The upper ends of the sidewalls are provided with a pair of aligned holes for receiving a common attaching bolt. The narrow portion of the slot extends across the floor and partially up the opposite sidewalls, where it intersects an enlarged access portion in each sidewall.

The shackle may be metal or synthetic resinous material such as Nylon. If constructed from metal, the crosshead of the attaching connection is long enough, compared to the width of the floor between sidewalls of the clip, to strike the sidewalls after a certain amount of limited, free rotation of the shackle about its longitudinal axis. If the shackle is constructed from synthetic resinous material, its integral body is formed into three main sections, i.e., a central shank, a connecting projection at the upper end of the shank, and a hock-engaging retainer at the lower end of the shank in the nature of a pair of leg loops disposed in a common plane. The shank is preferably rectangular in transverse cross-section, while the leg loops have cylindrical limbs that are circular in transverse cross-section. The limbs can yield and bend to a certain extent without becoming permanently deformed, but if subjected to excessive external force will break apart so as to prevent damage to whatever structure or mechanism maybe applying the bending force to the shackle, whereupon the broken shackle can be discarded and replaced by a new one.

### BRIEF DESCRIPTION OF THE DRAWINGS

FIG. 1 is a fragmentary, front elevational view of a poultry carcass conveyor line incorporating shackle assemblies constructed in accordance with the principles of the present invention, the phantom lines indicating poultry carcasses hanging from the shackle assemblies;

FIG. 2 is a side elevational view of one of the shackle assemblies and carcass, with portions of the conveyor being shown in cross-section;

FIG. 3 is an enlarged, fragmentary isometric view of a prior art shackle assembly;

FIG. 4 is an enlarged, fragmentary, exploded isometric view of one embodiment of the invention using a prior art clip;

FIG. 5 is an enlarged front elevational view of the prior art clip with a front corner thereof broken away to reveal details of construction;

FIG. 6 is a vertical cross-sectional view of the prior art clip taken substantially along line 6-6 of FIG. 5;

FIG. 7 is a horizontal cross-sectional view of the prior art clip taken substantially along line 7-7 of FIG. 5;

FIG. 8 is an enlarged, fragmentary front elevational view of the shackle assembly of FIG. 4, the phantom lines illustrating how the shackle can rock side-to-side within the clip;

FIG. 9 is a vertical cross-sectional view of the shackle assembly of FIG. 4 taken substantially along line 9-9 of FIG. 8, the phantom lines illustrating how the shackle can swing in-and-out within the clip;

FIG. 10 is a horizontal cross-sectional view taken substantially along line 10-10 of FIG. 8;

FIG. 11 is a horizontal cross-sectional view taken substantially along line 11-11 of FIG. 8, illustrating the manner in which the shackle is free to experience limited rotation about its longitudinal axis to the extent permitted by an anti-rotation bar immediately below the head of the shackle;

FIG. 12 is a fragmentary isometric view of the shackle assembly of FIG. 4 with a front comer of the clip broken away to illustrate the manner in which the retaining head of the shackle normally sits transversely across the slot in the clip;

FIG. 13 is a front elevational view of a prior art shackle assembly in which both the clip and shackle are constructed in accordance with the teachings of the prior art, the shackle being devoid of an anti-rotation bar, and phantom lines illustrating the manner in which the shackle can swing from side-to-side;

FIG. 14 is a vertical cross-sectional view of the prior art shackle assembly of FIG. 13 taken substantially along line 14-14 of FIG. 13;

FIG. 15 is a fragmentary isometric view of another embodiment of shackle assembly (using the prior art clip) in which the shackle is constructed from metal and is free to rotate about its longitudinal axis within the limits determined by the opposite ends of the cross head striking the sidewalls of the clip;

FIG. 16 is a front elevational view of the FIG. 15 embodiment with parts broken away and shown in cross-section for clarity, the phantom lines illustrating the manner in which the shackle can swing from side-to-side;

FIG. 17 is a vertical cross-sectional view of the FIG. 15 embodiment taken substantially along line 17-17 of FIG. 16, the phantom lines illustrating the manner in which the shackle can swing in and out;

FIG. 18 is a horizontal cross-sectional view of the FIG. 15 embodiment taken substantially along line 18-18 of FIG. 16, the phantom lines illustrating the manner in which the shackle is free to rotate to a limited extent about its longitudinal axis;

FIG. 19 is a fragmentary, exploded isometric view of another embodiment of shackle assembly in which a molded synthetic resinous clip is utilized;

FIG. 20 is an enlarged, front elevational view of the clip of the FIG. 19 embodiment;

FIG. 21 is a vertical cross-sectional view thereof taken substantially along line 21-21 of FIG. 20;

FIG. 22 is a top plan view of the clip of the FIG. 19 embodiment taken substantially along line 22-22 of FIG. 20;

FIG. 23 is a front elevational view of the shackle assembly of the FIG. 19 embodiment with parts broken away and shown in cross-section for clarity, the phantom lines illustrating the manner in which the shackle can swing from side-to-side;

FIG. 24 is a vertical cross-sectional view of the FIG. 19 embodiment taken substantially along line 24-24 of FIG. 23, the phantom lines illustrating the manner in which the shackle can swing in and out;

FIG. 25 is a horizontal cross-section view of the FIG. 19 embodiment taken substantially along line 25-25 of FIG. 23, the phantom lines illustrating the manner in which the shackle is free to experience limited rotation about its longitudinal axis;

FIG. 26 is a fragmentary, exploded isometric view of a further embodiment of shackle assembly (using the prior art clip) wherein the shackle has an oval-shaped head and an anti-rotation bar beneath the head;

FIG. 27 is a front elevational view of the FIG. 26 embodiment with the upturned front portion of the clip broken away and the shackle swung upwardly and rearwardly to illustrate that the length dimension of the oval head exceeds the width of the entry slot;

FIG. 28 is a top plan view of the FIG. 26 embodiment with the rear sidewall of the clip broken away, a rotated position of the shackle head being illustrated by phantom lines;

FIG. 29 is a fragmentary, exploded isometric view of another embodiment of shackle assembly (using the prior art clip) wherein the shackle has an oval-shaped head but no anti-rotation bar beneath the head;

FIG. 30 is a front elevational view of the FIG. 29 embodiment with the upturned front portion of the clip broken away and the shackle swung upwardly and rearwardly to illustrate that the length dimension of the oval head exceeds the width of the entry slot; and

FIG. 31 is a top plan view of the FIG. 29 embodiment with the rear sidewall of the clip broken away, a rotated position of the shackle head being illustrated by phantom lines.

### DETAILED DESCRIPTION

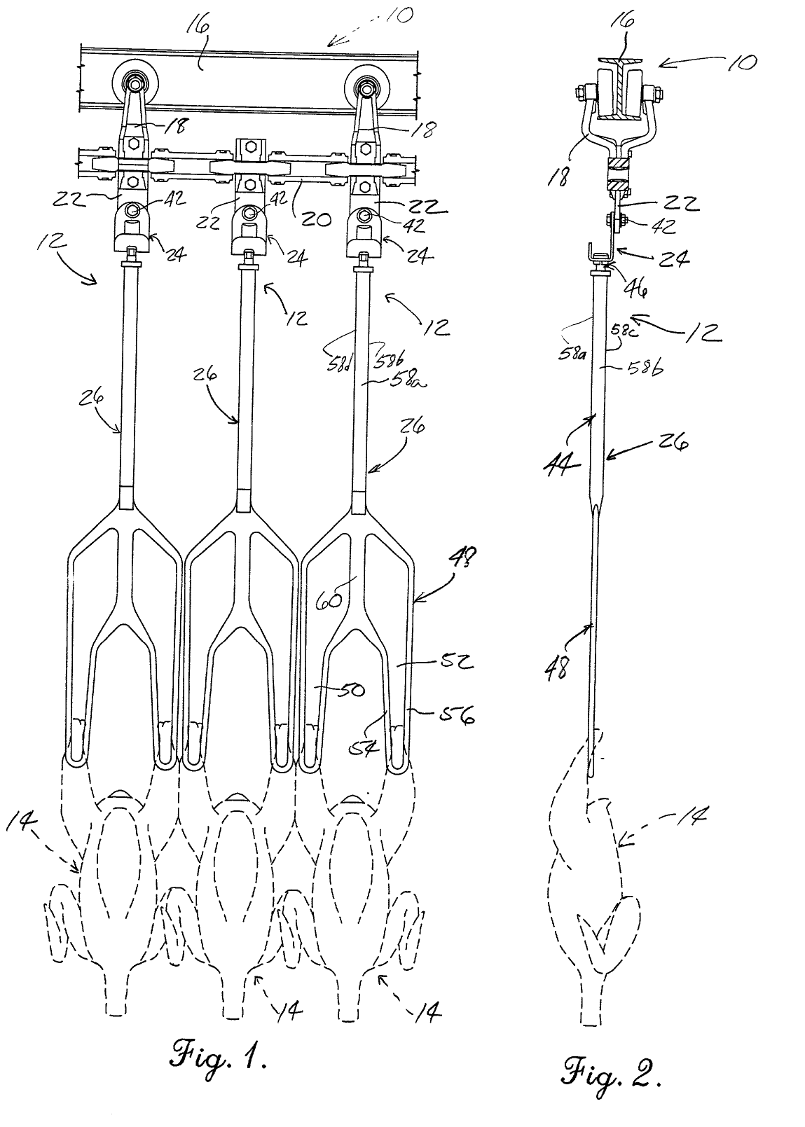

FIGS. 1 and 2 illustrate an overhead conveyor 10 utilizing shackle assemblies 12 in accordance with the present invention to transport poultry carcasses 14 through a processing plant. As well understood by those skilled in the art, conveyor 10 includes a track 16 having series of trollies 18 hanging therefrom for travel therealong, the trollies 18 being interconnected by a link chain 20. Each trolley 18 has a hanger 22 projecting downwardly therefrom, there also being a hanger 22 supported from the chain 20 between each pair of trollies 18.

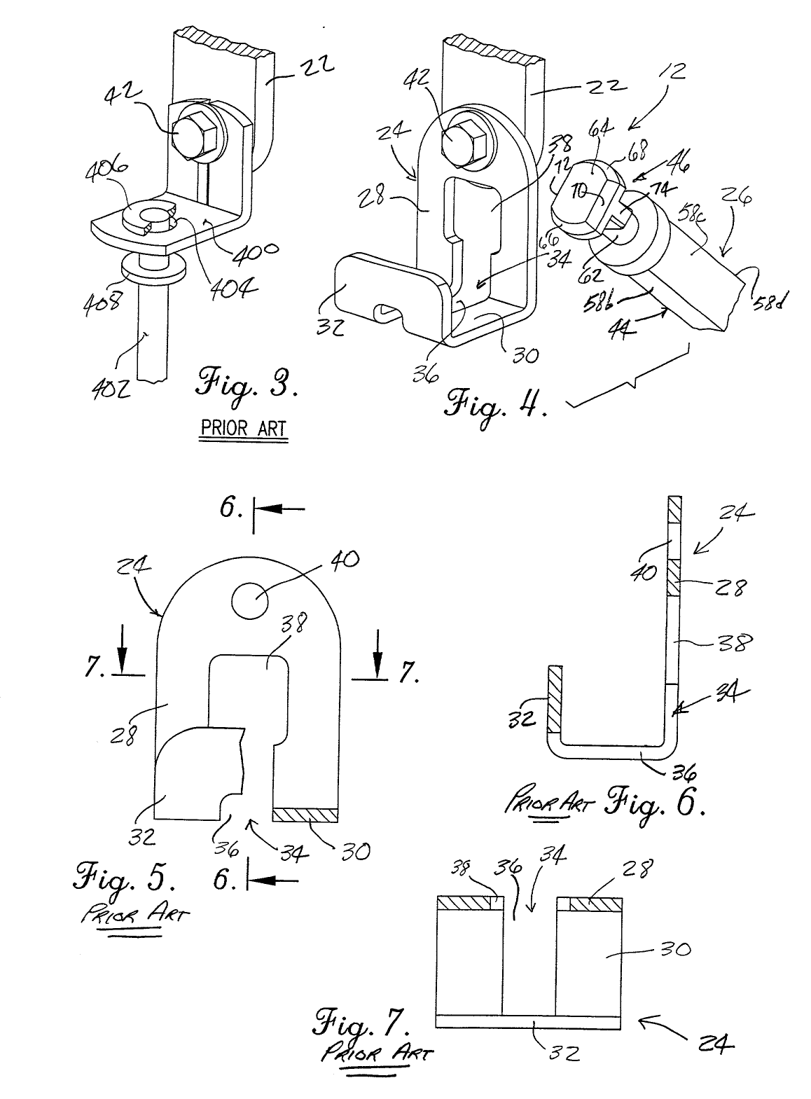

Each shackle assembly 12 has two main parts, i.e., a prior art clip 24 essentially permanently fastened to the hanger 22, and a shackle 26 that is detachably secured to the clip 24 without the use of fasteners. Dealing first with the prior art clip 24, it will be seen from the detail views in FIGS. 4-7 that the clip is generally L-shaped in side elevation, having an upright sidewall 28 and a normally horizontally extending floor 30 projecting outwardly from the sidewall 28. Floor 30 is upturned at its end remote from the sidewall 28 so as to present a short second sidewall 32 spaced laterally outwardly from the first sidewall 28. Floor 30 and short sidewall 32 are cantilevered from the sidewall 28.

Clip 24 has a key slot 34 therein that is closed at its opposite ends and that extends generally axially of the longitudinal axis of the clip. Slot 34 includes a narrow portion 36 that runs along the floor 30 and up the sidewall 28 until intersecting with an enlarged, rectangular access portion 38 of slot 34. At its other end, the narrow portion 36 extends up the sidewall 32 for a short distance. A mounting hole 40 is located in sidewall 28 adjacent the upper end thereof and above the enlarged portion 38. Hole 40 is adapted to receive a bolt assembly 42 for essentially permanently fastening clip 24 to hanger 22. In its preferred form, clip 24 is cut from a piece of sheet metal, is punched to form the key slot 34, and is bent to assume the general L-shaped configuration with the two sidewalls 28 and 32.

In the illustrated embodiment, the shackle 26 comprises a unitary body of synthetic resinous material, for example, Nylon 6. Shackle 26 comprises three major portions or sections, i.e., a central elongated shank 44, a connector 46 at the upper end of shank 44, and a leg-engaging retainer 48 at the lower end of shank 44 (which may hold the birds either by their hocks or their feet). Retainer 48 has a pair of leg loops 50,52 that receive and retain the hocks of the carcass 14 so that the carcass 14 is suspended in an inverted position as illustrated in FIGS. 1 and 2. Each leg loop 50,52 includes a pair of inner and outer limbs 54 and 56 respectively that are of substantially circular cross-sectional configuration. Limbs 50 and 56 can flex and bend without being permanently deformed due to their synthetic resinous construction. The cross-sectional diameter of limbs 54,56 is such that, taking into account the material from which they are fabricated, limbs 54 and 56 can break under the application of sufficient bending force thereto, such breakage occurring in lieu of the limbs taking any permanent deformation. As noted particularly in FIG. 2, leg loops 50,52, lie in a common plane.

Shank 44 of shackle 26 is rectangular in transverse cross-sectional configuration, presenting four flat sides 58 that maybe described as a front side 58a, a left side 58b, a back side 58c, and a right side 58d. Front and back sides 58a,58b are parallel to the plane of the leg loops 52, while left and right sides 58b,58d are perpendicular to the plane of leg loops 50,52. Flat-sided shank 44 transitions into the rounded limbs 54,56 of retainer 48 at the bottom end of shank 44. A central generally flat stiffening strut 60 in the retainer 48 extends vertically in essentially axial alignment with the shank 44 and connects with the outer limbs 56 at their upper ends and the shorter inner limbs 54 at their upper ends.

The connector 46 of shackle 26 is in the nature of a generally T-shaped projection having an axially disposed, cylindrical neck 62 of circular cross-sectional configuration and a cross-head 64 extending transversely of the neck 62 across its upper end. Head 64 is symmetrically disposed upon the neck 62, projecting in opposite directions therefrom to an equal extent. Head 64 is elongated in a direction parallel to the plane of the leg loops 50,52, as well as parallel to the plane of the front and back sides 58a,58c of shank 44. Head 64 has a pair of opposite, rounded ends 66, 68, as well as a pair of opposite straight sides 70,72. Head 64 is both longer and wider than the width of the narrow portion 36 of slot 34. On the other hand, while head 64 is slightly longer than the vertical dimension of the enlarged access portion 38, it is slightly narrower than the width dimension of enlarged portion 38. The length dimension of head 64 is measured between the opposite rounded ends 66,68, while the width dimension is measured between the opposite flat sides 70,72.

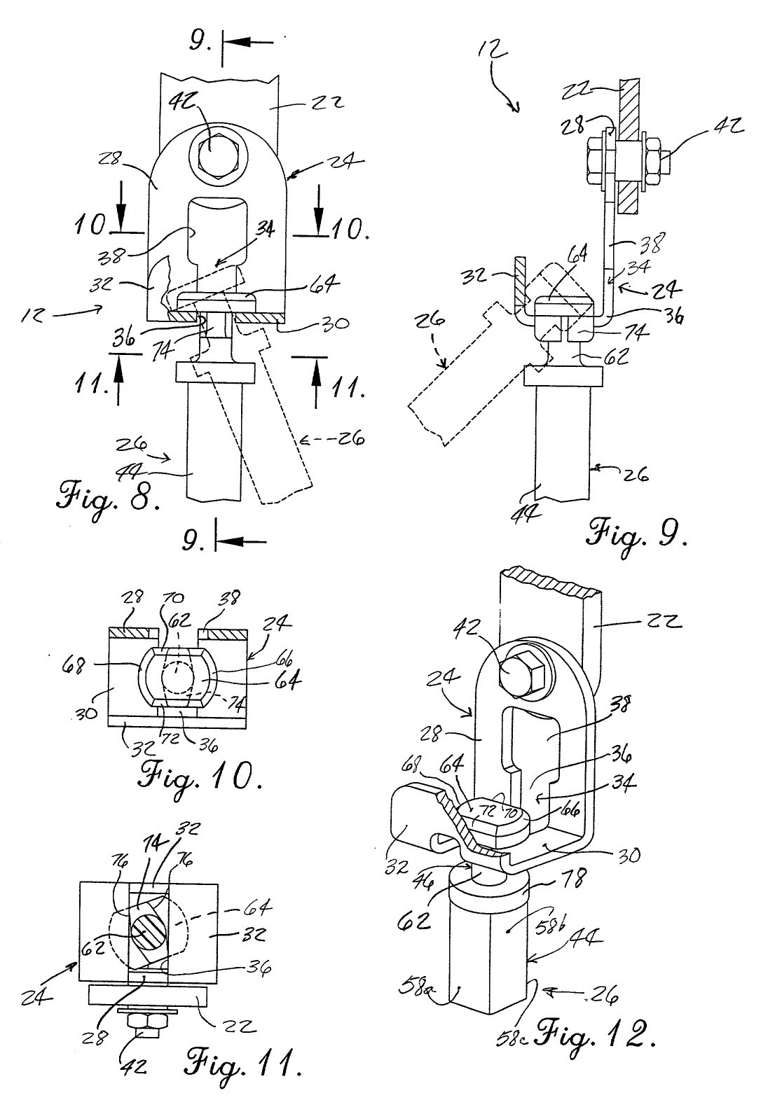

In the illustrated embodiment, the connector 46 of shackle 26 further includes an anti-rotation bar 74 immediately below the head 64 and above the neck 62. As shown particularly in FIGS. 8-12, neck 62 is slightly smaller in diameter than the width of the narrow portion 36 of slot 34. Likewise, anti-rotation bar 74 has a width dimension that essentially corresponds with the diameter of neck 62 such that bar 74 is flush with neck 62 essentially in the mid-section of bar 74 such that bar 74 is received within the narrow portion 36 of the slot when bar 74 is disposed in alignment with slot 34. On the other hand, the longitudinal dimension of the bar 74 is substantially greater than the width of the narrow slot portion 36, the bar 74 terminating at its opposite ends substantially flush with the flat sides 70,72 of head 64. The opposite ends of bar 74 are preferably tapered so as to present converging faces 76, such tapering configuration thus permitting a limited degree of axial rotation of shackle 26 when bar 74 is disposed within narrow slot portion 36 as illustrated in FIG. 11, for example. Such limited rotation is on the order of 15° degrees in each direction. As is apparent, bar 74 is elongated in a direction perpendicularly transverse to the direction of elongation of head 64 such that the longitudinal axis of bar 74 is perpendicular to the common plane of the leg loops 50,52. A circular collar 78 at the base of neck 62 is spaced below bar 74 and substantially exceeds the width dimensions of slot 34. Except for the presence of anti-rotation bar 74, shackle 26 is identical to prior art shackle 126 of FIGS. 13 and 14.

Operation

In use, the shackles 26 are suspended from the clips 24 for movement along a processing line defined generally by the conveyor 10. Poultry carcasses 14 are suspended by their hocks from the leg loops 50,52 of shackles 46 so that various processing and inspection operations can be carried out thereon. Shackles 26 are suspended by their loose interconnections with the clips 24 via the slots 34 in clips 24 and the connectors 46 on shackles 26. At this time, anti-rotation bars 74 are received within the narrow slot portions 36, while the heads 64 are disposed transversely of and overlie narrow slot portions 36 as illustrated in FIG. 12.

With the upper ends of the shackles 26 loosely connected to the clips 24 in this manner, shackles 26 are free to swing from side-to-side to a limited extent as illustrated, for example, in FIG. 8. Similarly, they are free to swing in and out to a limited extent as illustrated in FIG. 9. Furthermore, although anti-rotation bar 74 on each shackle is intended to prevent free rotation of the shackle about its longitudinal axis, the tapered ends of each bar 74 permit a small amount of axial rotation of each shackle, on the order of 15 degrees or so in each rotative direction, as illustrated in FIG. 11.

Such freedom of movement at the point of connection between shackle 26 and clip 24 is helpful and important as the carcasses travel throughout the processing plant. For example, during inspection of the carcasses at various locations, it is necessary for the inspector to be able to grab the moving carcass and manipulate it in the manner necessary to carry out the inspections. Further, the shackles frequently need to move around bends, be swung in and out, and be hanging at an angle relative to the clips as the shackles are engaged by various guiding structures and are subjected to the force of gravity while the trollies 18 remain in generally fixed attitudes relative to the track 16.

The flats on the various faces of shank 44 are helpful in maintaining the carcasses 14 properly oriented as the shackles engage guide rods and other structures throughout the processing operations. Thus, the flat sides of shank 44 help prevent unintended rotation of the carcasses during travel and manipulation. Of course, the anti-rotation bars 74 provide the primary means of protection against rotation, but the flat shank sides are helpful in this respect as well and take some of the load off the surfaces of the bar 74.

In the event that there is a need to intentionally rotate the carcasses more than the limited amount of rotation provided by the tapered ends of the anti-rotation bar 74, the shackle to be rotated simply needs to be grasped and pushed upwardly a sufficient distance as to dispose bar 74 above narrow slot portion 36 and neck 62 within such portion. Normally, this position will be established when the lower limit collar 78 butts up against the bottom of the floor 30. With the anti-rotation bar 74 thus cleared from narrow slot portion 36, shackle 26 can be freely rotated to any desired position, it being noted that the length of head 64 is slightly less than the distance between the opposite sidewalls 28,32 such that the sidewalls do not interfere with head 64 during such rotation. When it is desired to lock shackle 26 back in an orientation that precludes substantial rotation, it is only necessary to realign the bar 74 with narrow slot portion 36 and allow shackle 26 to drop down slightly until head 64 engages clip floor 30.

In the event that a shackle becomes broken or removal is desired for any other reason, such can be quickly and easily accomplished without the use of hand tools and without manipulating any fasteners. First, the conveyor line 10 is disengaged so that it is no longer moving. Then, it is only necessary to grasp the shackle 26 and swing it upwardly and rearwardly generally in the manner illustrated in FIG. 4 until head 64 is within enlarged portion 38, whereupon shackle 26 maybe freely rotated because of the excessive width dimension of enlarged portion 38 relative to the length dimension of anti-rotation bar 74. Once shackle 26 has been rotated 90° degrees about its longitudinal axis so as to generally align head 64 with the longitudinal axis of slot 34, shackle 26 may be angled upwardly or downwardly to a sufficient extent as to cause one or the other of the rounded ends 66,68 of head 64 to slip angularly through the enlarged portion 38. Once one end of head 64 starts angularly through enlarged slot portion 38, the rest of head 64 can be brought easily out of portion 38 until the shackle 26 is entirely disconnected from clip 24.

Replacement of the damaged shackle with a new shackle is equally simple. By orienting the shackle in the manner illustrated in FIG. 4, head 64 is generally aligned with slot 34. Since enlarged portion 38 is slightly shorter than the overall length of head 64, head 64 must be somewhat inclined as illustrated in FIG. 4 in order for one or the other of the opposite ends 66,68 to enter portion 38. Once an end such as lower end 66 in the FIG. 4 illustration has entered and passed substantially through the enlarged slot portion 38, the shackle can be brought up to a substantially horizontal position and head 64 pushed completely through enlarged slot portion 38 until it is disposed on the front side of sidewall 28. Thereupon, rotation of the shackle 90° about its longitudinal axis causes anti-rotation bar 74 to become aligned with slot 34 and head 64 to be disposed transverse thereto, whereupon shackle 26 can be brought down into a vertical hanging disposition as illustrated in FIG. 12 wherein head 64 transversely overlies and spans narrow slot 36 and bears against floor 30 to support the weight of the rest of the shackle and the carcass 14.

Other Embodiments

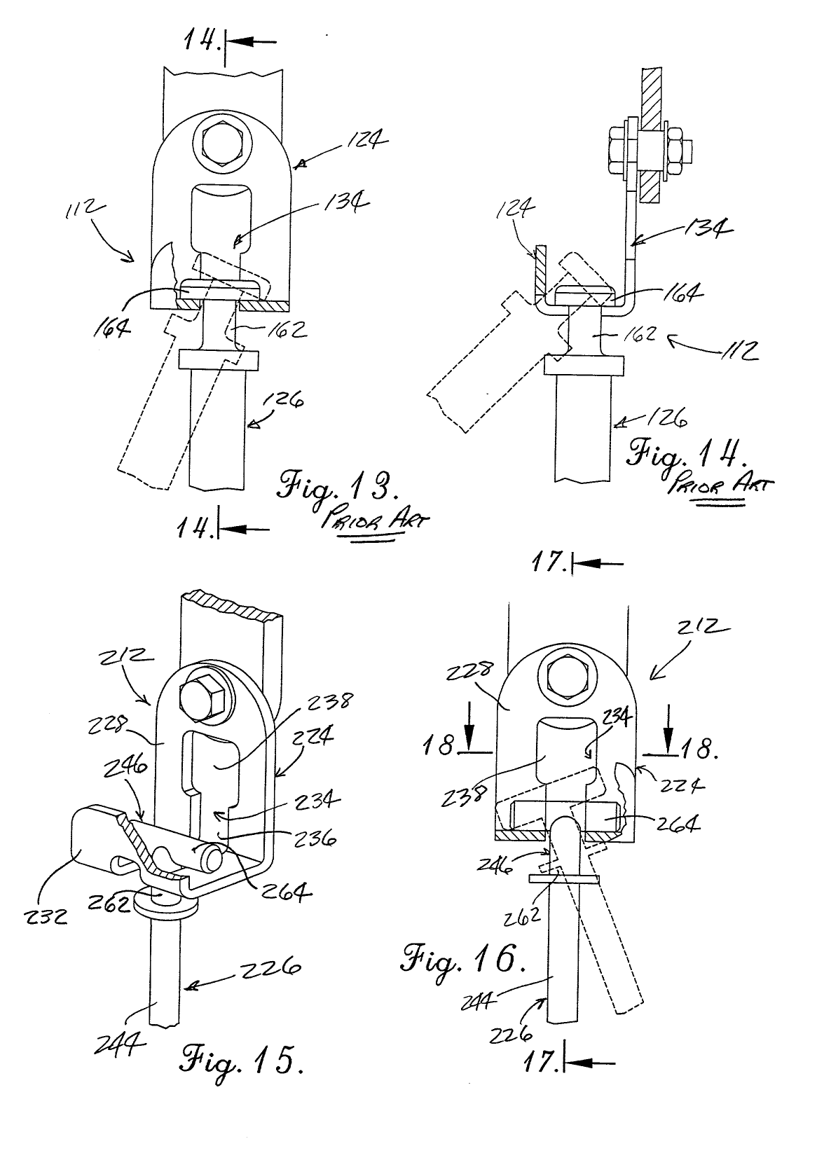

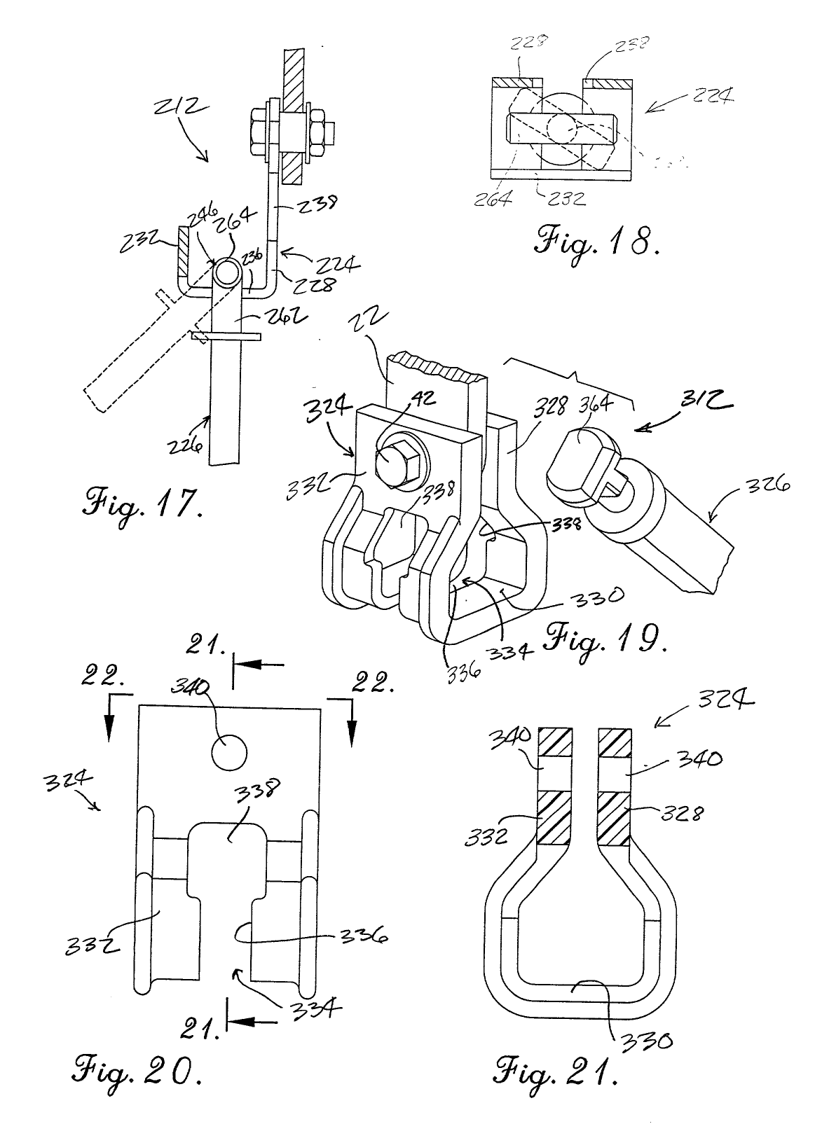

The embodiment illustrated in FIGS. 15-18 is a shackle assembly 212 that is especially well-suited for a metal shackle 226. Clip 224 is identical to the prior art metal clip previously described, but shackle 226 differs from shackles 26 and 126, in part because it is constructed from metal. In the embodiment of FIGS. 15-18, shank 244 is cylindrical so as to be circular in cross-sectional configuration. The connector projection 246 remains generally T-shaped, but cross head 264 is likewise cylindrical and is the same diameter as shank 244 and neck 262. No anti-rotation bar is provided between head 264 and neck 262, but head 264 is preferably of such a length that its opposite ends strike sidewalls 228 and 232 of clip 224 when rotation of shackle 226 about is longitudinal axis is attempted, as illustrated in FIG. 18. Due to the narrowness of head 264 relative to the space between front and rear sidewalls 232 and 228, shackle 226 can experience a limited amount of rotation about its longitudinal axis before head 264 engages sidewalls 228,232.

Removal of shackle 226 from clip 224 is carried out in essentially the same manner as in the earlier embodiments, i.e., after swinging shackle 226 backwardly and upwardly into an essentially horizontal position, the shackle may be rotated about its longitudinal axis to dispose head 264 essentially in line with slot 234. Then, head 264 maybe simply slipped through slot 234 to disengage shackle 226, since the diameter of head 264 is less than the width of slot 234, even in the narrow slot portion 236. Replacement of shackle 226 is a simple reversal of this process. It will be apparent that due to the nature of head 264, it is not necessary for slot 234 to have an enlarged portion 238, although such an arrangement permits the same style of clip to be used with any of the herein disclosed styles of shackles. As noted in FIGS. 16 and 17, shackle 226 can also be swung from side-to-side and in and out.

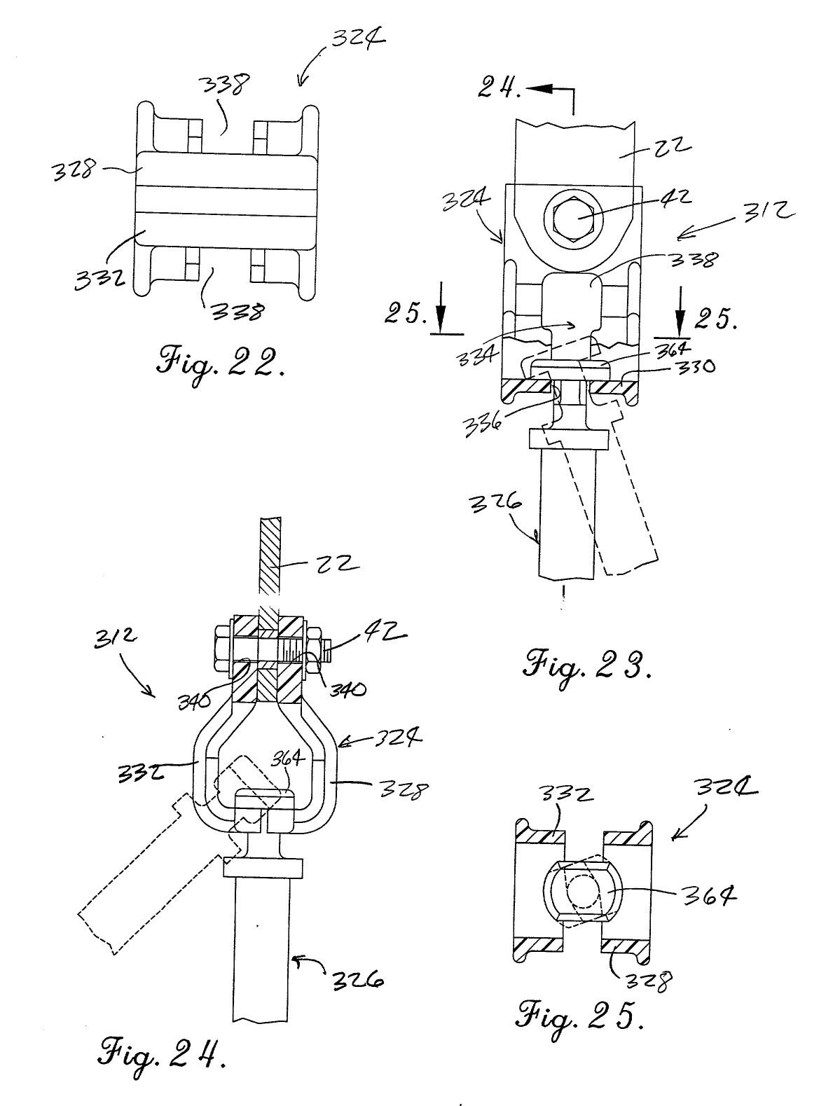

FIGS. 19-25 illustrate another shackle assembly 312 in which shackle 326 is identical to shackle 26 but clip 324 is different. The primary difference with respect to clip 324 is that, like shackle 326, clip 324 is most advantageously constructed from synthetic resinous material such as Nylon 6. Due to the lack of overall strength, however, of synthetic resinous material as compared to metal, clip 324 is generally transversely U-shaped, instead of L-shaped, such that both front and rear sidewalls thereof are adapted to be attached to the hanger 22 instead of only the rear sidewall 28 as in the earlier embodiments.

In clip 324, both front sidewall 332 and rear sidewall 328 are provided with attaching holes 340 adjacent their upper ends for receiving the bolt assembly 42 associated with hanger 22. Thus, in clip 324, the hanger 22 is sandwiched between the front and rear sidewalls 332 and 328 so that both sidewalls support the load of the shackle 326 and the carcass.

It will be noted that sidewalls 328,332 are mirror images of one another such that they correspond in height to one another. Further, it will be noted that the slot 334 has a pair of enlarged portions 338 at its opposite closed ends, instead of only a single enlargement as in previous embodiments. Thus, in the embodiment of FIGS. 19-25, the narrow portion 336 of slot 334 runs across the entire width of floor 330 and up the opposite sidewalls 328, 332 until intersecting with the enlarged portions 338 approximately halfway up sidewalls 328,332.

As a result of the double access openings in clip 324 provided by enlargements of 338, shackle 326 may be attached and detached from clip 324 from either the front or the back. In either case, the method of removal and reinsertion of the head 364 of shackle 326 is essentially the same as that described above with respect to shackle 26 and clip 24. It will also be noted that shackle 326 is free to move to a limited extent from side-to-side as illustrated in FIG. 3, and from front to rear as illustrated in FIG. 24. Additionally, shackle 326 can rotate to a limited extent about its longitudinal axis as illustrated in FIG. 25.

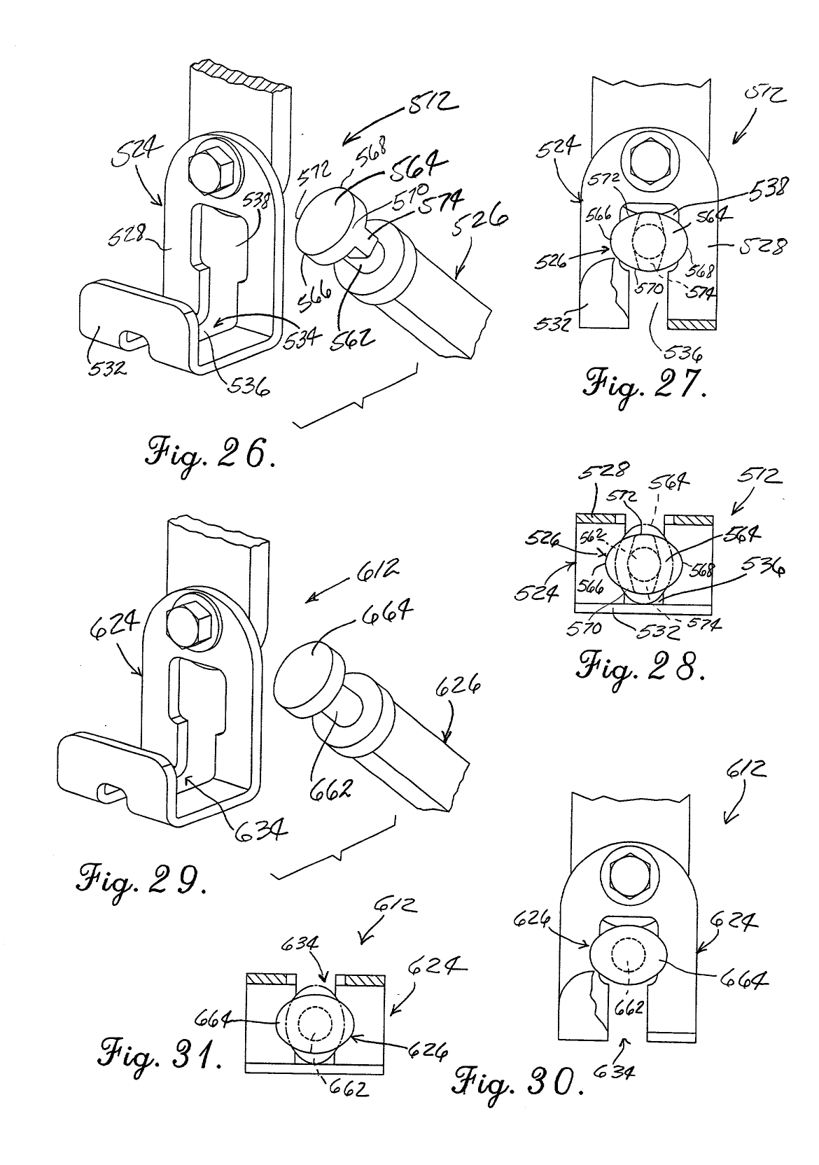

FIGS. 26-28 illustrate an additional embodiment of shackle assembly designated by the numeral 512. Shackle assembly 512 is identical to assembly 12, except for the shape of head 564. Whereas in the earlier embodiment the head of the projection was generally rectangular as viewed in plan, head 564 is generally oval as viewed in plan. Head 564 has its longitudinal axis extending generally parallel to the common plane of the leg loops (not shown) of the shackle 526, with the anti-rotation bar 574 extending transversely of the common plane of the leg loops.

Head 564 has arcuate side edges 570 and 572, as well as arcuate opposite ends 566 and 568 of smaller radius than side edges 570,572. Bar 574 terminates at its opposite ends substantially flush with arcuate side edges 570 and 572. Neck 562 is of such diameter as to be freely rotatable within slot 534 of clip 524 when shackle 526 is lifted upwardly to such an extent as to raise bar 574 out of slot 534.

As illustrated in FIG. 27, the oval head 574 has a length dimension that slightly exceeds the width of enlarged portion 538 of slot 534 in clip 524. Thus, even if shackle 526 is swung upwardly and rearwardly into a substantially horizontal position as illustrated in FIG. 27, head 564 continues to overlap enlarged portion 538 to discourage accidental release of shackle 526 from slot 534. However, by slightly cocking or twisting shackle 526 when it is in this position, head 564 may be slipped through enlarged portion 538 even without rotating shackle 526 90°.

The width dimension of head 564 between side edges 570 and 572 is slightly less than the width of enlarged portion 538. Consequently, if shackle 526 is rotated 90° from its FIG. 27 position, head 564 can be pulled rearwardly straight through enlarged portion 538 without twisting cocking shackle 526.

It will also be seen from FIG. 28 that the length dimension of head 564 between opposite ends 566 and 568 is significantly larger than the width of the narrow portion 536 of slot 534. Furthermore, the width dimension of head 564 between side edges 570 and 572 is somewhat greater than the width of narrow slot portion 536. The length dimension of head 564 between opposite end edges 566 and 568 is somewhat less than the distance between sidewalls 528 and 532 of clip 524 so that head 564 does not interfere with free rotation of shackle 526 when anti-rotation bar 574 is up out of slot 534 and neck 562 is aligned with slot 534.

FIGS. 29-31 illustrate a further embodiment of shackle assembly denoted by the numeral 612. In this embodiment, shackle assembly 612 is identical to shackle assembly 512 except that no anti-rotation bar is provided. Thus, neck 662 of shackle 626 extends up into intersection with the bottom of oval shaped head 664 without the presence of an anti-rotation bar immediately below head 664. Shackle 626 is thus free to rotate at all times within slot 634 of clip 624.

Prior Art Constructions

FIG. 3 illustrates a prior art shackle assembly attached to the hanger 22 of the conveyor by means of the bolt assembly 42. The prior art shackle assembly has a generally L-shaped metal clip 400 that supports a metal shackle 402. Shackle 402 is permanently affixed to clip 400 such that it cannot be removed from the conveyor unless clip 400 is unbolted from hanger 22 using hand tools. The cylindrical shank of shackle 42 passes loosely through an enlarged hole 404 in the horizontal leg of clip 400, and a retaining washer 406 is welded to the uppermost end of the shackle. A lower stop collar 408 is welded to the shackle a distance below washer 406 so that a limited amount of vertical motion of the shackle is permitted. In view of the cylindrical nature of the shackle and the enlarged dimensions of the hole 404 compared thereto, shackle 402 is free to rotate within hole 404.

FIGS. 13 and 14 illustrate a prior art shackle assembly which is identical to assembly 12, except that shackle 26 of assembly 12 is provided with the anti-rotation bar 74 while the prior art assembly, denoted by the numeral 112, has none. Thus, neck 162 of shackle 126 extends completely up to and intersects with the bottom of head 164 such that shackle 126 is free to rotate at all times about its longitudinal axis within slot 134 of clip 124. All other motions of shackle 126, as illustrated in FIGS. 13 and 14, are the same as those permitted with shackle assembly 12.

Although preferred forms of the invention have been described above, it is to be recognized that such disclosure is by way of illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of their invention as pertains to any apparatus not materially departing from but outside the literal scope of the invention as set out in the following claims.

1. A shackle for poultry carcasses comprising:
an elongated, central shank;
a connector at the upper end of said shank adapted to be removably secured to an overhead conveyor; and
a leg-engaging retainer at the lower end of said shank,
said connector comprising a projection having a neck extending upwardly from said shank and a head across the upper end of said neck that is wider than the neck,
said connector further including an anti-rotation bar between the head and the neck.

2. A shackle as claimed in claim 1,
said retainer including a pair of laterally spaced leg loops lying in a common plane,
said bar extending transversely of said common plane of the leg loops.

3. A shackle as claimed in claim 1,
said head being elongated,
said bar being elongated in a direction transverse to the direction of elongation of the head.

4. A shackle as claimed in claim 1,
said bar having a pair of opposite, tapered ends.

5. A shackle as claimed in claim 1,
said head having a pair of opposite, longitudinal, side edges,
said bar having a pair of opposite ends terminating flush with said side edges.

6. A shackle as claimed in claim 1,
said bar having a width dimension that is equal to or less than the diameter of said neck.

7. A shackle as claimed in claim 1,
said head being generally rectangular as viewed in plan.

8. A shackle as claimed in claim 7,
said head having a pair of opposite straight sides and a pair of opposite rounded ends.

9. A shackle as claimed in claim 1,
said head being generally oval as viewed in plan.

10. A shackle as claimed in claim 1,
said shank, said connector, and said retainer comprising integrally connected portions of a unitary, synthetic resinous body.

11. A shackle for poultry carcasses comprising:
an elongated, central shank;
a connector at the upper end of said shank adapted to be removably secured to an overhead conveyor; and
a leg-engaging retainer at the lower end of said shank,
said connector comprising a projection having a neck extending upwardly from said shank and a head across the upper end of said neck that is wider than the neck,
said head being generally oval as viewed in plan.

12. A shackle as claimed in claim 11,
said connector further including an anti-rotation bar between the head and the neck.

13. A shackle as claimed in claim 12,
said retainer including a pair of laterally spaced leg loops lying in a common plane,
said bar extending transversely of said common plane of the leg loops.

14. A shackle as claimed in claim 13,
said head being elongated,
said bar being elongated in a direction transverse to the direction of elongation of the head.

15. A shackle as claimed in claim 14,
said head having its longitudinal axis extending generally parallel to said common plane of the leg loops.

16. A shackle as claimed in claim 12,
said bar having a pair of opposite, tapered ends.

17. A shackle as claimed in claim 12,
said head having a pair of opposite, arcuate, side edges,
said bar having a pair of opposite ends terminating flush with said side edges.

18. A shackle as claimed in claim 12,
said bar having a width dimension that is equal to or less than the diameter of said neck.

19. A shackle as claimed in claim 11,
said retainer including a pair of laterally spaced leg loops lying in a common plane,
said head being elongated with its longitudinal axis extending generally parallel to said common plane of the leg loops.

20. A shackle as claimed in claim 11,
said shank, said connector, and said retainer comprising integrally connected portions of a unitary, synthetic resinous body.

21. A quick-attach shackle assembly for poultry carcasses comprising:
a clip adapted to be fastened to an overhead conveyor; and
a shackle detachably connectable to said clip without fasteners,
said clip having at least one upright wall, a floor projecting laterally from the base of said wall, and a continuous, open slot having a pair of opposite, closed ends,
said slot extending across the floor and up said one wall,
said shackle including a central shank, a connector at the upper end of the shank receivable within said slot of the clip, and a leg-engaging retainer at the lower end of the shank,
said connector comprising a projection having a neck extending upwardly from said shank and a head across the upper end of the neck that is wider than the neck,
said slot including an enlarged access portion in said at least one wall at one end of the slot dimensioned to permit entry and exit of the head of the projection therethrough,
said slot further including a narrower retaining portion leading downwardly from said access portion and across the floor,
the dimensions of said head relative to said narrower retaining portion being such that entry and exit of the head from the slot can only occur through said access portion,
said connector further including an anti-rotation bar between the head and the neck,
said bar being sized to fit into the slot and prevent rotation of the shackle when the head is seated against the floor of the clip.

22. A shackle assembly as claimed in claim 21,
said retainer including a pair of laterally spaced leg loops lying in a common plane,
said bar extending transversely of said common plane of the leg loops.

23. A shackle assembly as claimed in claim 21,
said head being elongated,
said bar being elongated in a direction transverse to the direction of elongation of the head.

24. A shackle assembly as claimed in claim 21,
said bar having a pair of opposite, tapered ends.

25. A shackle assembly as claimed in claim 21,
said head having a pair of opposite, longitudinal, side edges,
said bar having a pair of opposite ends terminating flush with said side edges.

26. A shackle assembly as claimed in claim 21,
said bar having a width dimension that is equal to or less than the diameter of said neck.

27. A shackle assembly as claimed in claim 21,
said head being generally rectangular as viewed in plan.

28. A shackle assembly as claimed in claim 27,
said head having a pair of opposite straight sides and a pair of opposite rounded ends.

29. A shackle assembly as claimed in claim 21,
said head being generally oval as viewed in plan.

30. A shackle assembly as claimed in claim 21,
said clip further comprising a second wall spaced from said at least one wall and extending upwardly from the floor,
the other closed end of the slot being located generally at the base of said second wall.

31. A shackle assembly as claimed in claim 21,
said clip further including a second wall spaced from said at least one wall and extending upwardly from the floor,
said slot extending upwardly from said floor in said second wall,
said opposite closed ends of the slot being in said walls,
said slot having a second enlarged access portion at the closed end of the slot in said second wall,
said narrower portion of the slot extending continuously between and interconnecting the two enlarged access portions of the slot.

32. A shackle assembly as claimed in claim 31,
said walls being of substantially the same height,
each of said walls having a hole located above the corresponding access portion of the slot for receiving a fastener used in attaching the clip to the conveyor.

33. A shackle assembly as claimed in claim 32,
said clip being constructed from a synthetic resinous material.

34. A shackle assembly as claimed in claim 21,
said shank, said connector, and said retainer comprising integrally connected portions of a unitary, synthetic resinous body.

35. A quick-attach shackle assembly for poultry carcasses comprising:
a clip adapted to be fastened to an overhead conveyor; and
a shackle detachably connectable to said clip without fasteners,
said clip having at least one upright wall, a floor projecting laterally from the base of said wall, and a continuous, open slot having a pair of opposite, closed ends,
said slot extending across the floor and up said one wall,
said shackle including a central shank, a connector at the upper end of the shank receivable within said slot of the clip, and a leg-engaging retainer at the lower end of the shank,
said connector comprising a projection having a neck extending upwardly from said shank and a head across the upper end of the neck that is wider than the neck,
said slot including an enlarged access portion in said at least one wall at one end of the slot dimensioned to permit entry and exit of the head of the projection therethrough,
said slot further including a narrower retaining portion leading downwardly from said access portion and across the floor,
the dimensions of said head relative to said narrower retaining portion being such that entry and exit of the head from the slot can only occur through said access portion,
said head being generally oval as viewed in plan.

36. A shackle assembly as claimed in claim 35,
said connector further including an anti-rotation bar between the head and the neck.

37. A shackle assembly as claimed in claim 36,
said retainer including a pair of laterally spaced leg loops lying in a common plane,
said bar extending transversely of said common plane of the leg loops.

38. A shackle assembly as claimed in claim 37,
said head being elongated,
said bar being elongated in a direction transverse to the direction of elongation of the head.

39. A shackle assembly as claimed in claim 38,
said head having its longitudinal axis extending generally parallel to said common plane of the leg loops.

40. A shackle assembly as claimed in claim 36,
said bar having a pair of opposite, tapered ends.

41. A shackle assembly as claimed in claim 36,
said head having a pair of opposite, arcuate, side edges,
said bar having a pair of opposite ends terminating flush with said side edges.

42. A shackle assembly as claimed in claim 36,
said bar having a width dimension that is equal to or less than the diameter of said neck.

43. A shackle assembly as claimed in claim 35,
said retainer including a pair of laterally spaced leg loops lying in a common plane,
said head being elongated with its longitudinal axis extending generally parallel to said common plane of the leg loops.

44. A shackle assembly as claimed in claim 35,
said clip further including a second wall spaced from said at least one wall and extending upwardly from the floor,
said slot extending upwardly from said floor in said second wall,
said opposite closed ends of the slot being in said walls,
said slot having a second enlarged access portion at the closed end of the slot in said second wall,
said narrower portion of the slot extending continuously between and interconnecting the two enlarged access portions of the slot.

45. A shackle assembly as claimed in claim 44,
said walls being of substantially the same height,
each of said walls having a hole located above the corresponding access portion of the slot for receiving a fastener used in attaching the clip to the conveyor.

46. A shackle assembly as claimed in claim 45,
said clip being constructed from a synthetic resinous material.

47. A shackle assembly as claimed in claim 35,
said shank, said connector, and said retainer comprising integrally connected portions of a unitary, synthetic resinous body.

48. A clip for use in detachably supporting a shackle for poultry carcasses comprising:
a pair of upright walls, each having a base;
a floor interconnecting said walls at their bases; and
a continuous, open slot extending across the floor and up said walls,
said slot having a pair of opposite, closed ends located in said walls.

49. A clip as claimed in claim 48,
said slot having a pair of enlarged access portions at opposite ones of said closed ends of the slot,
said slot further including a narrower portion extending continuously between and interconnecting said enlarged access portions.

50. A clip as claimed in claim 49,
said walls being of substantially the same height,
each of said walls having a hole located above the corresponding access portion of the slot for receiving a fastener used in attaching the clip to the conveyor.

51. A clip as claimed in claim 50,
said clip being constructed from a synthetic resinous material.

52. A clip as claimed in claim 48,
said clip being constructed from a synthetic resinous material.
